(19) United States
(12) Patent Application Publication
(10) Pub. No.: US 2009/0031062 A1
(43) Pub. Date: Jan. 29, 2009

(54) MODULARIZED MOTHERBOARD

(75) Inventors: Cheng-Lai Shen, Taipei (TW); Yueh-Chih Chen, Taipei (TW); Pei-Hua Sun, Taipei (TW); Chung-Ta Chin, Taipei (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: ASUSTeK COMPUTER INC., Taipei (TW)

(21) Appl. No.: 12/175,466

(22) Filed: Jul. 18, 2008

(30) Foreign Application Priority Data
Jul. 25, 2007 (TW) 96127054

(51) Int. Cl. G06F 13/00

(52) U.S. Cl. 710/100

(57) ABSTRACT

A modularized motherboard is provided. The modularized motherboard includes a first circuit board, a second circuit board and a connecting device. The first circuit board includes a north bridge chip, a central processing unit (CPU) slot and a first connecting port. The CPU slot is coupled to the north bridge chip and is used for installing a CPU. The second circuit board is independent of the first circuit board. The second circuit board includes a second connecting port and a south bridge chip. The south bridge chip is coupled to the north bridge chip via the second connecting port the first connecting port. The connecting device is coupled between the first connecting port and the second connecting port.

### CROSS-REFERENCE TO RELATED APPLICATION

This application claims the priority benefit of Taiwan application serial no. 96127054, filed on Jul. 25, 2007. The entirety of the above-mentioned patent application is hereby incorporated by reference herein and made a part of specification.

### BACKGROUND OF THE INVENTION

1. Field of the Invention

The invention relates to a motherboard and, more particularly, to a modularized motherboard.

2. Description of the Related Art

A conventional computer system mostly consists of a motherboard, interface cards and peripheral devices, and the motherboard is regarded as the heart of the computer system. As for the design of the conventional motherboard, all functional major components such as a central processing unit (CPU), a control chip set, slots for installing interface cards and memory slots are designed to be disposed on one printed circuit board (PCB).

In the conventional motherboard, standards and functions of all the components are constant. Therefore, after a user buys the conventional motherboard, he cannot change the standards of the components or update the components. If the user wants to change the configuration of the computer system to increase the whole performance, he can only replace the components such as a memory, a CPU and a graphic card independent of the motherboard.

Along with the progress of the science and technology, standards (such as serial advanced technology attachment (SATA), peripheral component interface (PCI) express) of the above components may be changed to increase the performance. Then, if the user wants to use the new standards, he should replace the motherboard at the same time. If a user only needs to replace part of the motherboard to upgrade some components instead of replacing the whole motherboard, and the performance of the computer can also be improved, the motherboard certainly become welcome.

### BRIEF SUMMARY OF THE INVENTION

The invention provides a modularized motherboard. When some components needs to be replaced with components with new standards, or some function ports are damaged, users do not need to replace a whole motherboard, and they only need to replace part of the motherboard to obtain the improved computer performance or restore original functions of the motherboard.

The invention provides a modularized motherboard. The modularized motherboard includes a first circuit board, a second circuit board and a connecting device. The first circuit board includes a north bridge chip, a central processing unit (CPU) slot and a first connecting port. The CPU slot is coupled to the north bridge chip and is used for installing a CPU. The second circuit board is independent of the first circuit board. The second circuit board includes a second connecting port and a south bridge chip. The south bridge chip is coupled to the north bridge chip via the second connecting port and the first connecting port. The connecting device is coupled between the first connecting port and the second connecting port.

The invention utilizes a modularized mode to divide a conventional motherboard into two circuit boards and allow slots of devices (such as a CPU, a memory or a graphic card) which are often upgraded or changed to be provided on one circuit board. If some function ports of the motherboard are damaged, or performance of some assembly needs to be improved, users can only replace the circuit board which includes the function ports or the assembly. Therefore, the users do not need to replace the whole motherboard because of the upgrade or change of some of the devices or damaged function ports.

These and other features, aspects, and advantages of the present invention will become better understood with regard to the following description, appended claims, and accompanying drawings.

### BRIEF DESCRIPTION OF THE SEVERAL VIEWS OF THE DRAWINGS

FIG. 1 is a block diagram showing a modularized motherboard of an embodiment of the invention.

FIG. 2A is a three-dimensional schematic diagram showing a modularized motherboard and a connecting device of an embodiment of the invention.

FIG. 2B is a three-dimensional schematic diagram showing a modularized motherboard and a connecting device of another embodiment of the invention.

FIG. 3 is a block diagram showing a modularized motherboard of another embodiment of the invention.

FIG. 4 is a block diagram showing a modularized motherboard and a power supplier of an embodiment of the invention.

FIG. 5 is a three-dimensional schematic diagram showing a modularized motherboard and a plate of an embodiment of the invention.

FIG. 6 is a block diagram showing a modularized motherboard and a power supplier of another embodiment of the invention.

### DETAILED DESCRIPTION OF THE EMBODIMENTS

After a motherboard is modularized, grounding portions of circuit boards are separated. When signals step from one circuit board to another circuit board, return paths may increase, which causes the performance of the modularized motherboard to be bad. Therefore, to avoid the above condition, before the motherboard is modularized, functions of modules need to be determined, number of signals between the modules and power sources need to be calculated, and characteristics or types of signal such as a high speed signal, a low speed signal and an power source need to be distinguished. On a conventional motherboard, a north bridge chip is in charge of controlling a CPU, a system memory and a graphic device besides communicating with a south bridge chip. The north bridge chip is designed to process high speed signals, and the south bridge chip is mostly in charge of controlling input output (I/O) interfaces and processing low speed signals. Therefore, in the following embodiments, a modularized motherboard is divided with the north bridge chip and the south bridge chip as a division basis.

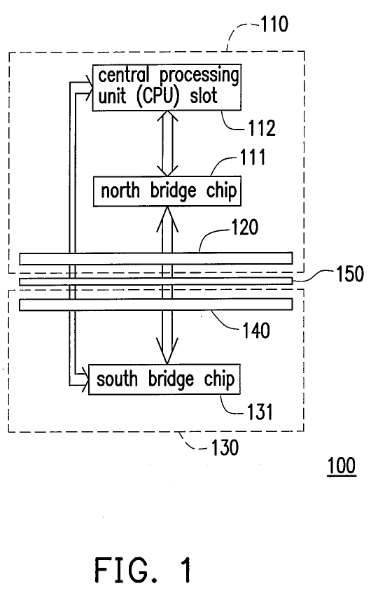

FIG. 1 is a block diagram showing a modularized motherboard 100 of an embodiment of the invention. As shown in FIG. 1, the modularized motherboard 100 includes a first circuit board 110, a second circuit board 130 and a connecting device 150. The second circuit board 130 is independent of the first circuit board 110 (that is, the first circuit board 110 and the second circuit board 130 are not the same printed circuit board). The connecting device 150 is coupled between a first connecting port 120 on the first circuit board 110 and a second connecting port 140 on the second circuit board 130 to electrically connect signal lines gathered at the first circuit board 110 and the second circuit board 130, and then signals can be transmitted between the first circuit board 110 and the second circuit board 130. The connecting device 150 may be, for example, a flexible printed circuit (FPC), metal pins or ribbon cables.

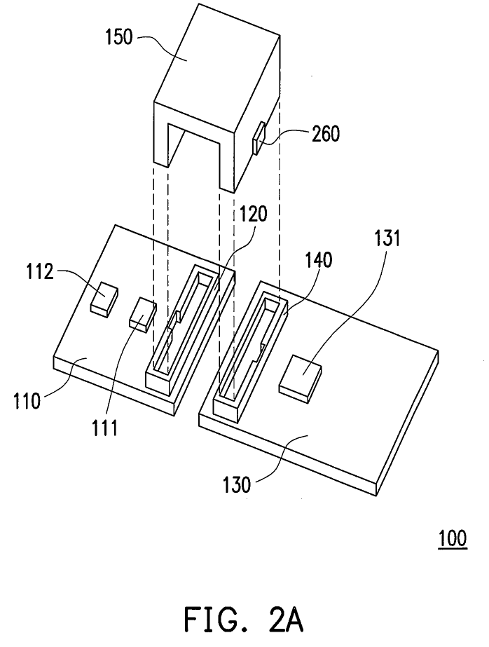

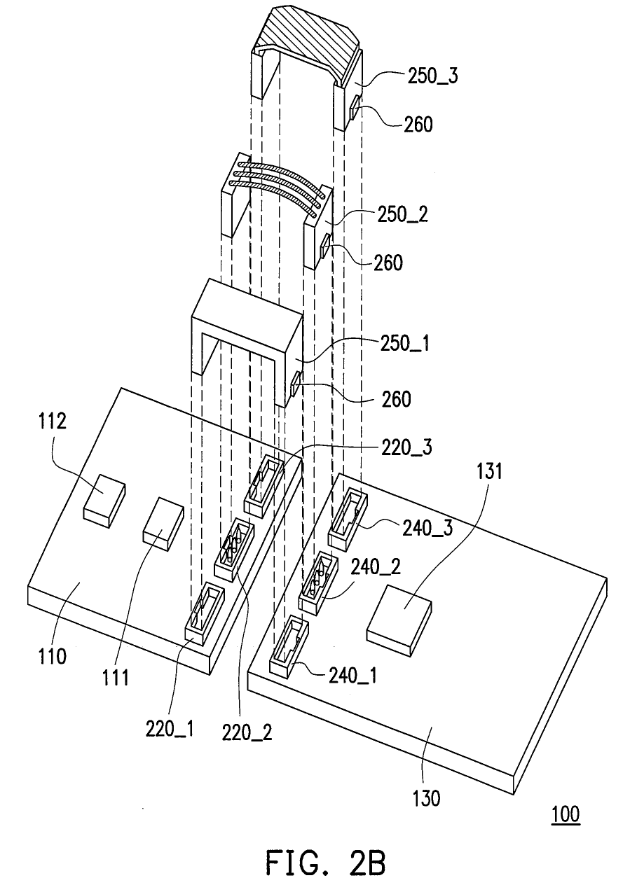

The mode of connecting the first connecting port 120 and the second connecting port 140 by the connecting device 150 is shown in FIG. 2A. As shown in FIG. 2A, each of the first connecting port 120 and the second connecting port 140 is a slot, and therefore, one connecting device 150 can be used to connect the signal lines of the first circuit board 110 and the second circuit board 130. The invention is not limited by the implementing mode in FIG. 2A, and designers can correspondingly divide the connecting device 150, the first connecting port 120 and the second connecting port 140 into a plurality of connecting devices, first connecting ports and second connecting ports according to types of signals (such as high speed signals, low speed signals and an power source). For example, as shown in FIG. 2B, the first connecting port is divided into the first connecting ports 220_1, 220_2 and 220_3, the second connecting port is divided into the second connecting ports 240_1, 240_2 and 240_3, and the connecting devices 250_1, 250_2 and 250_3 are used to connect the signal lines on the first circuit board 110 and the second circuit board 130.

For example, low speed signal lines can be connected via the first connecting port 220_1, the connecting device 250_1 (such as a FPC) and the second connecting port 240_1; power signal lines can be connected via the first connecting port 220_2, the connecting device 250_2 (such as a connector having metal pins) and the second connecting port 240_2; high speed signal lines can be connected via the first connecting port 220_3, the connecting device 250_3 (such as a FPC having a GND shielding function or ribbon cables) and the second connecting port 240_3, and then signals can be transmitted between the first circuit board 110 and the second circuit board 130.

When the connecting device 150 is installed incorrectly, the signal lines are also connected incorrectly, which may cause components provided on the first circuit board 110 and the second circuit board 130 to be damaged. Therefore, the connecting device 150 (namely, the connecting devices 250_1, 250_2 and 250_3) may have, for example, a fool proof function (such as a protrudent portion 260 of the connecting devices in FIG. 2A and FIG. 2B) to prevent the connecting device 150 (namely, the connecting devices 250_1, 250_2 and 250_3) from being connected to the first connecting port 120 (namely, 220_1, 220_2 and 220_3) and the second connecting port 140 (namely, 240_1, 240_2 and 240_3) incorrectly.

As shown in FIG. 1, the first circuit board 110 includes the north bridge chip 111, a CPU slot 112 and the first connecting port 120. The CPU slot 112 is coupled to the north bridge chip 111 and is used for installing a CPU. The first connecting port 120 gathers the signal lines for transmitting signals to the second circuit board 130 on the first circuit board.

The second circuit board 130 includes a south bridge chip 131 and the second connecting port 140. The south bridge chip 131 is coupled to the north bridge chip 111 and/or the CPU slot 112 via the second connecting port 140, the connecting device 150 and the first connecting port 120. The second connecting port 140 gathers the signal lines for transmitting signals to the first circuit board 110 on the second circuit board 130.

In the above embodiment, distribution positions and connection relationships of major components on the modularized motherboard 100 are only simply described. Other components of the modularized motherboard 100 are illustrated in the following embodiment of the invention. The following embodiment is only an implementing mode of the invention, and it is not used to limit the scope of the invention.

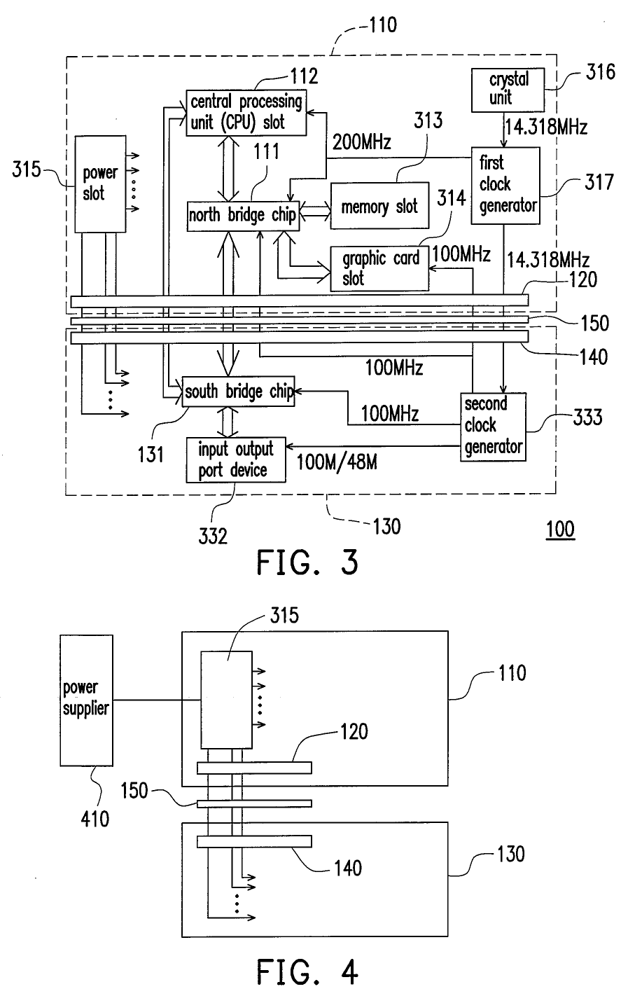

FIG. 3 is a block diagram showing a modularized motherboard of another embodiment of the invention. In the embodiment, the north bridge chip 111 is a graphic memory controller hub (GMCH) and is connected to the CPU, the memory and the graphic card. Therefore, as shown in FIG. 3, a memory slot 313 and a graphic card slot 314 are provided at the first circuit board 110. The south bridge chip 131 is called an input/output controller hub (ICH) for controlling input output (I/O) components, and therefore, as shown in FIG. 3, an input output port device 332 is provided at the second circuit board 130.

As shown in FIG. 3, the first circuit board 110 further includes the memory slot 313, the graphic card slot 314, a power slot 315, a crystal unit 316 and a first clock generator 317. The memory slot 313 is coupled to the north bridge chip 111 and is used for installing at least a memory. The graphic card slot 314 is coupled to the north bridge chip 111 and is used for installing a graphic card. The graphic card slot 314 is, for example, a peripheral component interface express (PCI-EX) x16 slot, an accelerated graphics port (AGP) slot and so on.

The power slot 315 is coupled to a power supplier 410 (as shown in FIG. 4) to provide a working voltage for the first circuit board 110. The power slot 315 can also transmit the power of the power supplier 410 to the second circuit board 130 via the first connecting port 120, the connecting device 150 and the second connecting port 140 to provide a working voltage for the second circuit board 130.

As shown in FIG. 3, the crystal unit 316 is used for providing a clock source. The first clock generator 317 is coupled to the crystal unit 316, and it provides the first clock signal and a second clock signal needed by the first circuit board 110 according to the clock source. The second clock signal is transmitted to the north bridge chip 111 and the CPU slot 112 to provide the north bridge chip 111 and the CPU with working clocks. In the embodiment, the frequency of the clock source and the first clock signal is about 14.318 MHz, and the frequency of the second clock signal is about 200 MHz.

The second circuit board 130 further includes the input output port device 332 and the second clock generator 333. The input output port device 332 is coupled to the south bridge chip 131 and is used for installing interface cards and connecting peripheral devices. The input output port device 332 is, for example, a PCI slot, a SATA interface, a USB interface or a sound card chip.

The second clock generator 333 receives the first clock signal outputted by the first clock generator 317 as its clock source via the second connecting port 140, the connecting device 150 and the first connecting port 120. The second clock generator 333 provides the third clock signal and the fourth clock signal for the second circuit board 130 according to the first clock signal. The third clock signal is transmitted to the south bridge chip 131 to provide a working clock for the south bridge chip. The third clock signal and the fourth clock signal are transmitted to the input output port device 332 to provide a working clock for the input output port device 332. The second clock generator 333 transmits the third clock signal to the north bridge chip 111 and the graphic card slot 314 of the first circuit board 110 via the second connecting port 140, the connecting device 150 and the first connecting port 120 to provide working clocks for the north bridge chip 111 and the graphic card. The second clock generator 333 transmits the third clock signal to the first circuit board 110 to allow the first circuit board 110 and the second circuit board 130 to be synchronous in clocks. In the embodiment, the frequency of the third clock signal is about 100 MHz, and the frequency of the fourth clock signal is about 48 MHz.

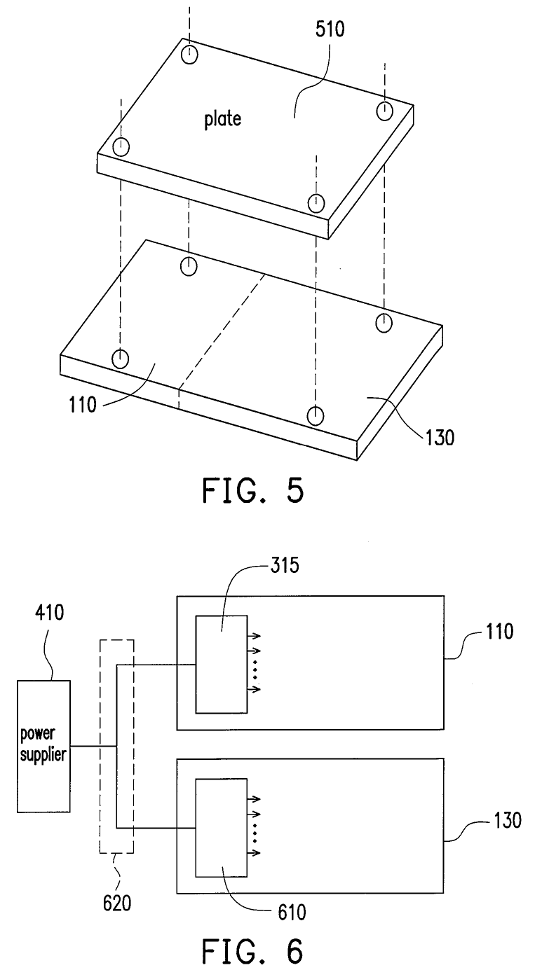

As shown in FIG. 5, the modularized motherboard 100 further includes a plate 510. The plate 510 is fixed at the back (such as a surface without components or a solder surface) of the first circuit board 110 and the second circuit board 130 via a fixing method (such as using a screw). After the modularized motherboard 100 is fixed via the plate 510, it looks like a conventional motherboard. The difference between the modularized motherboard 100 and the conventional motherboard is that a module (such as the first circuit board 110) of the modularized motherboard 100 can be replaced when related components need to be upgraded, or some of the function ports are damaged. However, the conventional motherboard can only be replaced in whole under the above conditions.

In the embodiment, the first circuit board 110 and the second circuit board 130 are provided with the first clock generator 317 and the second clock generator 333, respectively, to decrease overmuch high speed signals between the first circuit board 110 and the second circuit board 130. The clock source of the second clock generator 333 is provided by the first clock generator 317, and then a crystal unit for providing the clock source for the second clock generator 333 is saved. In this way, the complexity of designing the modularized motherboard 100 decreases.

The modularized motherboard 100 is obtained by dividing the conventional motherboard into the first circuit board 110 and the second circuit board 130. When the first circuit board 110 and the second circuit board 130 are manufactured, they can be manufactured to be printed circuit boards with different numbers of layers according to numbers of signal wiring. For example, the first circuit board 110 is a six-layer circuit board, and the second circuit board 130 is a four-layer circuit board. In this way, the manufacture cost of the modularized motherboard 100 decreases.

In another embodiment of the invention, it is not limited that only the first circuit board 110 is provided with the power slot 315, and the second circuit board 130 may also be provided with a second power slot 610 (as shown in FIG. 6). The power slot 315 and the second power slot 610 can be coupled to the power supplier 410 via a Y-shaped conducting wire 620 to obtain the working voltage needed by the first circuit board 110 and the second circuit board 130.

In another embodiment of the invention, the graphic card slot 314 is not limited to be provided on the first circuit board 110, and it can be provided at the second circuit board 130. The graphic card slot 314 provided at the second circuit board 130 can be designed to be controlled by the south bridge chip 131, or it can be connected to the north bridge chip 111 via the first connecting port 120, the connecting device 150 and the second connecting port 140 to be controlled by the north bridge chip 111.

The slot mentioned in the specification and claims is not limited to a material slot. For example, the CPU slot is a pin position which is suitable to receive a CPU slot or a pin position which is suitable to directly receive the CPU. Although a possible implementing mode of the modularized motherboard 100 is illustrated in the above embodiment, persons having ordinary skill in the art should know that design of the modularized motherboards 100 manufactured by different suppliers is different. Therefore, the invention is not limited to the above possible implementing mode. In other words, it meets with the spirit of the invention that the north bridge chip and the south bridge chip are used as a modularization basis to divide the motherboard into two parts.

To sum up, the invention at least has the following advantages.

First, the cost of replacing the motherboard because of disabled function ports can be saved via the modularized design.

Second, via the modularized design, only some of the functional modules need to be replaced to upgrade a computer when some of the functional modules need to be upgraded or when a user has a usage requirement such as an overclock requirement.

Third, via the modularized design, the manufacture cost decreases when motherboards are manufactured with PCBs having different numbers of layers.

Although the present invention has been described in considerable detail with reference to certain preferred embodiments thereof, the disclosure is not for limiting the scope of the invention. Persons having ordinary skill in the art may make various modifications and changes without departing from the scope and spirit of the invention. Therefore, the scope of the appended claims should not be limited to the description of the preferred embodiments described above.

What is claimed is:

1. A modularized motherboard comprising:
a first circuit board comprising:
a north bridge chip;
a central processing unit (CPU) slot which is coupled to the north bridge chip and is used for installing a CPU; and
a first connecting port;
a second circuit board which is independent of the first circuit board and comprises:
a second connecting port; and
a south bridge chip coupled to the north bridge chip via the second connecting port and the first connecting port; and
a connecting device coupled between the first connecting port and the second connecting port.

2. The modularized motherboard according to claim 1, wherein the first circuit board further comprises:
a memory slot which is coupled to the north bridge chip and is used for installing at least a memory.

3. The modularized motherboard according to claim 1, wherein the first circuit board further comprises:
a graphic card slot which is coupled to the north bridge chip and is used for installing a graphic card.

4. The modularized motherboard according to claim 3, wherein the graphic card slot comprises a peripheral component interface express (PCI-EX) x16 slot.

5. The modularized motherboard according to claim 1, wherein the first circuit board further comprises:
a power slot coupled to a power supplier to provide a working voltage for the first circuit board.

6. The modularized motherboard according to claim 5, wherein the power slot further provides a working voltage for the second circuit board via the first connecting port, the connecting device and the second connecting port.

7. The modularized motherboard according to claim 1, wherein the second circuit board further comprises:
a second power slot coupled to a power supplier to provide a working voltage for the second circuit board.

8. The modularized motherboard according to claim 1, wherein the first circuit board further comprises:
a crystal unit for providing a clock source; and
a first clock generator which is coupled to the crystal unit and is used for providing a first clock signal and a second clock signal according to the clock source.

9. The modularized motherboard according to claim 8, wherein the second circuit board further comprises:
a second clock generator receiving the first clock signal as its clock source via the first connecting port, the connecting device and the second connecting port and providing a third clock signal for the second circuit board according to the first clock signal.

10. The modularized motherboard according to claim 9, wherein the frequency of the third clock signal is about 100 MHz.

11. The modularized motherboard according to claim 9, wherein the second clock generator further provides a fourth clock signal for the second circuit board, and the frequency of the fourth clock signal is about 48 MHz.

12. The modularized motherboard according to claim 9, wherein the second clock generator further provides the third clock signal for the first circuit board via the second connecting port, the connecting device and the first connecting port.

13. The modularized motherboard according to claim 8, wherein the frequency of the second clock signal is about 200 MHz.

14. The modularized motherboard according to claim 8, wherein the frequency of the first clock signal is about 14.318 MHz.

15. The modularized motherboard according to claim 8, wherein the frequency of the clock source is about 14.318 MHz.

16. The modularized motherboard according to claim 1, wherein the connecting device comprises a flexible printed circuit (FPC).

17. The modularized motherboard according to claim 1, wherein the second circuit board further comprises:
an input output port device which is coupled to the south bridge chip and is used for installing an interface card.

18. The modularized motherboard according to claim 17, wherein the input output port device comprises a PCI slot, a serial advanced technology attachment (SATA) interface, a universal serial bus (USB) interface and a sound card chip.

19. The modularized motherboard according to claim 1, further comprising:
a plate for fixing the first circuit board and the second circuit board.
